(19) United States
(12) Patent Application Publication
(10) Pub. No.: US 2004/0014563 A1
(43) Pub. Date: Jan. 22, 2004

(54) Transmission shift control with engine torque control

(75) Inventors: Clayton George Janasek, Independence, KS (US); Jared Scott Dobbins, Pryor, OK (US); Timothy Douglas Rice, Independence, KS (US); Michael Duane Testerman, Dearing, KS (US); Michael John Pipho, Dunkerton, IA (US); Barry Edward Plassman, Cedar Falls, IA (US)

Correspondence Address: Joel S. Carter, Patent Department, DEERE & COMPANY, One John Deere Place, Moline, IL, 61265-8098, US

(73) Assignee: Deere & Company, a Delaware Corporation

(21) Appl. No.: 10/199,939

(22) Filed: Jul. 19, 2002

(51) Int. Cl. B60K 41/06

(52) U.S. Cl. 477/109

(57) ABSTRACT

A transmission controller determines a requested engine torque value. For an upshift the requested engine torque value is determined as a function of slippage of one of an off-going clutch. For a downshift, the requested engine torque value is determined as a function of actual sensed engine torque. The requested torque value is sent to an engine controller which controls the engine so that the engine generates the requested engine torque. Then the appropriate transmission clutches are swapped to complete the requested shift while the engine torque is controlled. The engine controller also limits engine torque to the requested engine torque value.

### FIELD OF THE INVENTION

The invention relates to a vehicle powershift transmission shift control system.

### BACKGROUND OF THE INVENTION

Modern vehicle powershift transmissions, such as the DF500 powershift transmission manufactured by Funk Manufacturing, or such as described in U.S. Pat. No. 5,557,978, issued Sep. 24, 1996 to McAskill, and assigned to the assignee of this Application, contain multiple electronically controlled, hydraulically actuated wet clutches. U.S. patent application Ser. No. 09/505,001, filed Feb. 15, 2000 (15035-US) describes an event-based shifting method wherein, during shifting from one transmission input to output speed ratio to another, two range clutches are exchanged, resulting in an interim transmission ratio. This interim transmission ratio is higher than the target ratio, thus resulting in a loss of mechanical advantage to the engine, and requiring additional torque from the engine to maintain a constant transmission output torque and constant vehicle (ground) speed.

In some transmissions during some shifts, the interim ratio can cause an extreme loss of mechanical advantage to the engine. In such cases, the engine cannot produce enough torque to maintain a constant transmission output torque and constant vehicle speed. This condition worsens as draft load on the vehicle increases. Vehicle operators perceive the loss of vehicle speed as a bad shift.

### SUMMARY OF THE INVENTION

Accordingly, an object of this invention is to provide a powershift transmission control system which reduces ground speed loss during a shift.

This and other objects are achieved by the present invention for a method of controlling, in response to a shift command, a commanded shift of a powershift transmission of an engine-driven vehicle. The transmission has an input shaft, an input section and fluid pressure operated clutches for controlling flow of torque through the transmission. The transmission includes output (range) clutches and speed clutches between the output clutches and the input shaft. According to the present invention, the transmission controller determines a requested engine torque value. For an upshift the requested engine torque value is determined as a function of slippage of the off-going output clutch. For a downshift, the requested engine torque value is determined as a function of actual sensed engine torque. The requested torque value is sent to the engine controller so that the engine generates the requested engine torque. Then the appropriate transmission clutches are swapped to complete the requested shift while the engine torque is controlled.

### BRIEF DESCRIPTION OF THE DRAWINGS

FIG. 1 is a schematic diagram of a transmission control system to which the present invention is applicable.

FIG. 2 is a schematic diagram of an example of a transmission to which the present invention is applicable.

FIG. 3 is a logic flow diagram of the algorithm executed by the transmission controller of FIG. 1.

### DESCRIPTION OF THE PREFERRED EMBODIMENT

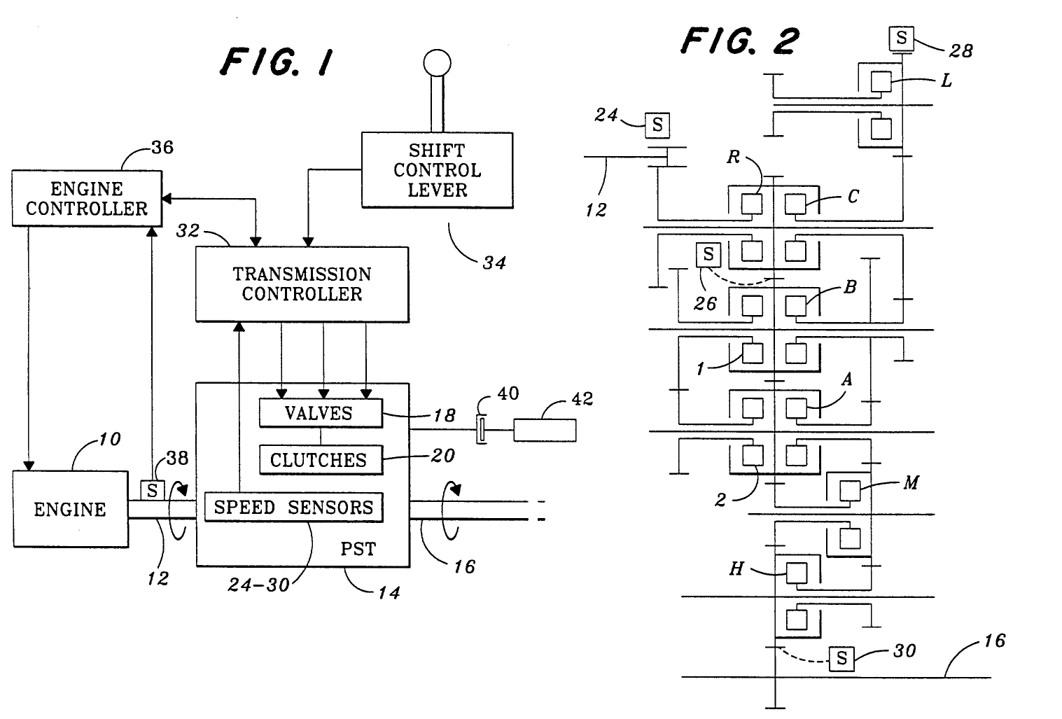

Referring to FIG. 1, a vehicle powertrain includes an engine 10 coupled to an input shaft 12 which drives a powershift transmission (PST) 14. The PST 14 drives an output shaft 16 which is connected to vehicle drive wheels (not shown). The PST 14 includes a plurality of clutch control valves 18 which are controlled by transmission controller 32. Clutch control valves 18 control a plurality of clutches 20, which in turn control the shifting of the PST 14. The PST 14 also includes a plurality of speed sensor 24-30 which provide speed signals to a transmission controller 32. Transmission controller 32 receives operator control signals from a shift control lever unit 34. The engine 10 is controlled by engine controller 36 which communicates with transmission controller 32 and which receives a speed signal from input shaft speed sensor 38. The PST drives a power take off (PTO) shaft 42 via a PTO clutch 40.

Referring to FIG. 2, the PST 14 includes directional clutches 1, 2 and R, speed clutches A, B and C, and output (or range) clutches L, M and H (which are connected directly or indirectly through constantly meshed gears to the transmission output shaft 16). The speed clutches are between the output clutches and the transmission input shaft 12. The input section of the PST 14 includes the shafts thereof, the speed of which is determined by the engagement status of the directional and speed clutches. The clutch control valves 18 are preferably electro-hydraulic valves which provide a pressure substantially proportional to the duty cycle of an electrical valve current signal applied to an input thereof, such as are part of the DF500 powershift transmission manufactured by Funk Manufacturing, or any similar valve.

A first speed sensor 24 is located on the 1^{st} Stage gear in order to sense the speed of the input (first stage) shaft 12. A second speed sensor 26 is located to sense the speed of a 3^{rd} stage shaft. A third speed sensor 28 is located to sense the speed of a 5^{th} stage shaft. A fourth speed sensor 30 is used to sense the speed of the output (8^{th} stage) shaft 16.

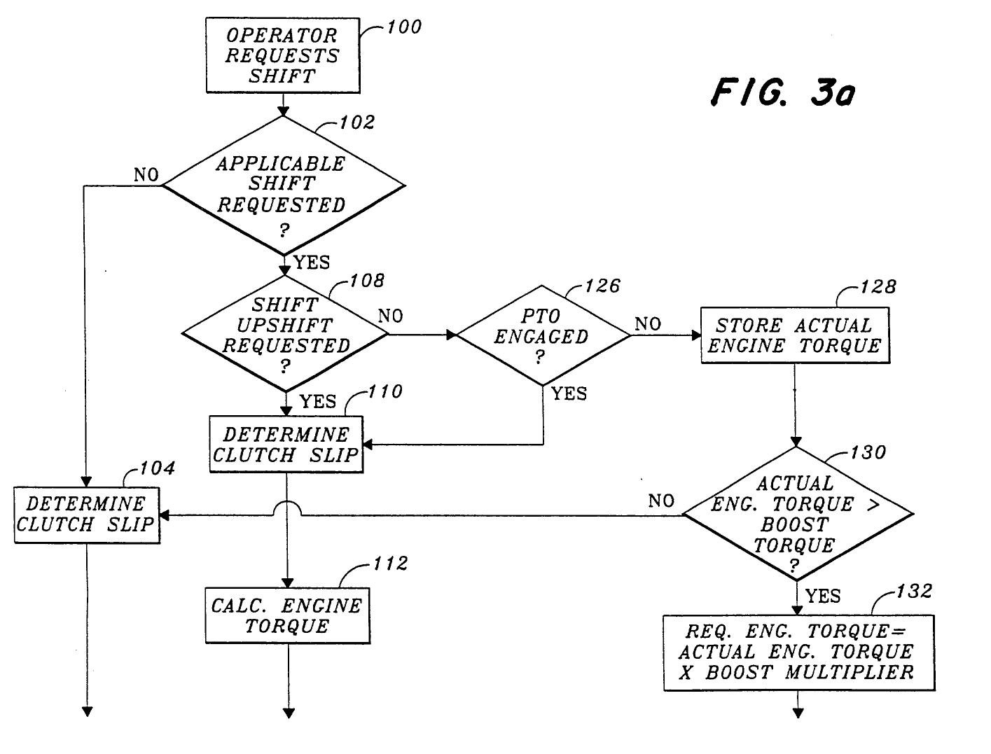

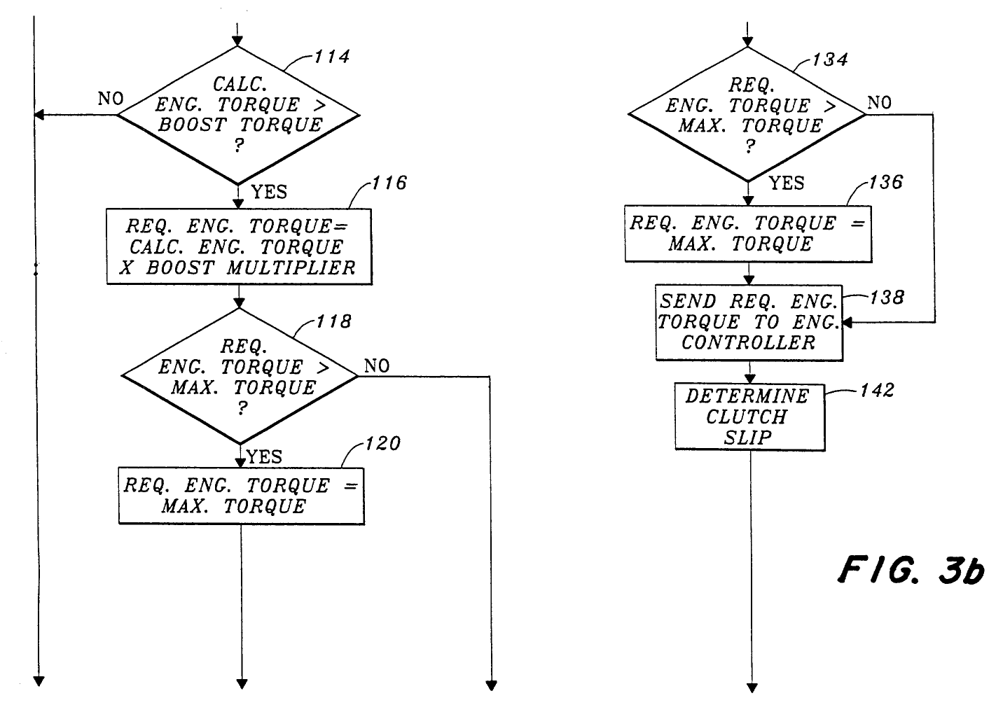

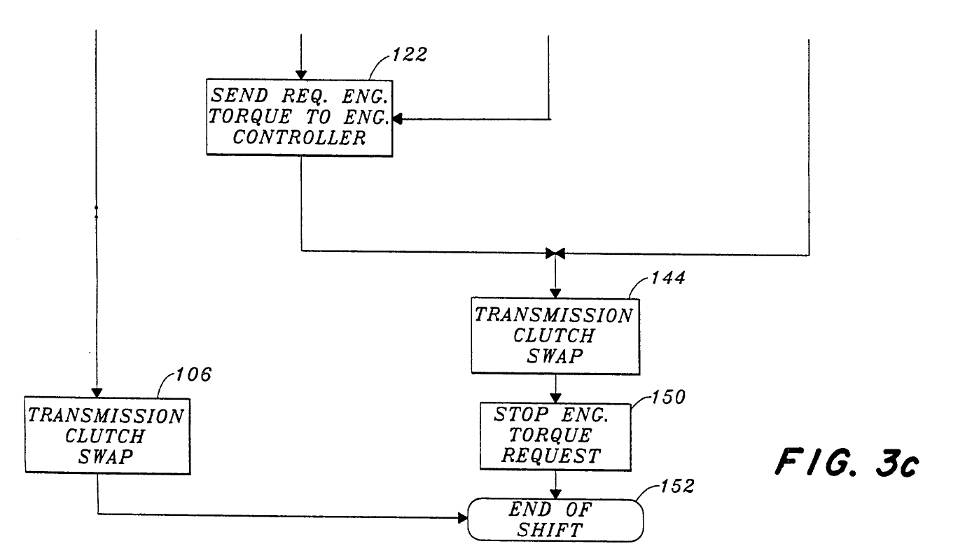

The PST 14 is controlled by a transmission controller 32 which receives signals from an operator controlled shift lever unit 34, and from speed sensors 24-30. The transmission controller 32 also receives a fuel flow signal from the electronic engine controller 36. This signal represents the actual engine load or torque. The transmission controller 32 is preferably a microprocessor-based control unit, such as is provided with the DF500 powershift transmission manufactured by Funk Manufacturing, or a similar microprocessor-based electronic control unit. The transmission controller 32 executes a control algorithm, and according to the present invention, executes a control subroutine such as illustrated by the logic flowcharts set forth in FIG. 3.

Referring to FIG. 3, there is shown a simplified representation of the algorithm 100, starting at step 100. Step 102 directs the algorithm to steps 104 and 106 if a shift other than a shift to which torque control applies is requested, such as in response to operator manipulation of shift control lever 34.

Step 104 gradually reduces the pressure applied to an off-going output clutch (such as clutch H) and determines when that clutch begins to slip, such as described more fully in U.S. Pat. No. 6,193,630, issued Feb. 27, 2001 and assigned to the assignee of the present application, and which is incorporated by reference herein. Step 106 performs the required clutch swaps to complete the requested shift as described in U.S. patent application Ser. No. 09/505,001, which is incorporated by reference herein.

Step 108 is executed if a shift to which toque control applies is being requested, such as in response to operator manipulation of shift control lever 34. For example, in the DF500 PST such a shift would be a forward 12^{th} gear to forward 13^{th} gear upshift, a forward 14^{th} gear to forward 13^{th} gear downshift, or a forward 12^{th} gear to forward 11^{th} gear downshift. In some other PST torque control could be applied to other shifts.

If an upshift is being requested, step 108 directs the algorithm to step 110, else to step 126.

Step 110 gradually reduces the pressure applied to an off-going clutch (such as clutch H) and determines when that clutch begins to slip, similar to step 104.

Step 112 calculates an engine torque value based on the clutch slip determined in step 110. This is done by using empirically determined linear relationships between engine torque load and clutch slip pressure for the particular clutch. For example, a known load is placed on the vehicle and the clutch pressure is reduced until a 2% clutch slip is detected, at which point the clutch pressure (psi) is recorded along with the value of the engine load signal (foot-pounds of torque). This is done across the range from low load to high load until enough data has been gathered to demonstrate the trend. Linear relationships are determined by applying linear regression techniques to this data. The resulting linear relationships are used to relate clutch slip pressure to engine torque. Preferably, two different intersecting linear relationships are used because above a certain engine torque, transmission internal drag becomes insignificant. The parameters for these linear relationships is stored in a memory (not shown) of the transmission controller 32.

Step 114 compares the calculated engine torque to a predetermined torque value at which engine boost is required. If the calculated engine torque is not greater than the predetermined torque value, then the algorithm proceeds to step 106 which performs the transmission clutch swaps required to complete the requested shift, as described in U.S. patent application Ser. No. 09/505,001, filed Feb. 15, 2000 (15035-US). Following step 106, the shift is complete and the algorithm ends at step 152.

If, in step 114, the calculated engine torque is greater than the predetermined torque value, then the algorithm proceeds to step 116.

Step 116 calculates a requested engine torque value as equal to the calculated engine torque value multiplied by a boost multiplier.

Step 118 compares the requested engine torque to a maximum allowed engine torque value. If the requested engine torque is not greater than the maximum allowed engine torque value, the algorithm proceeds to step 122. If the requested engine torque is greater than the maximum allowed engine torque value, the algorithm proceeds to step 120.

Step 120 sets the requested engine torque equal to the maximum allowed engine torque value.

Step 122 sends the requested engine torque value to the engine controller 36, and this causes the engine controller 36 to control the engine torque to achieve the requested engine torque.

Step 144 then performs a transmission clutch swap for the requested shift as described in previously mentioned U.S. patent application Ser. No. 09/505,001.

After the clutch swap has been completed, step 150 cancels the torque request to the engine controller 36 so that the engine controller 36 returns to its normal control mode.

Step 152 ends the shift.

Returning to step 126, if the PTO clutch 40 is engaged, the algorithm proceeds to previously described steps 110, else to step 128.

Step 128 reads and stores the actual engine torque which is derived from a signal generated by the engine controller 36.

Step 130 compares the actual engine torque to a predetermined torque value at which engine boost is required. If the calculated engine torque is not greater than the predetermined torque value, then the algorithm proceeds to steps 104 and 106 which perform a transmission clutch swap. If the calculated engine torque is greater than the predetermined torque value, then the algorithm proceeds to step 132.

Step 132 calculates a requested engine torque value as equal to the actual engine torque value multiplied by a boost multiplier.

Step 134 compares the requested engine torque to a maximum allowed engine torque value. If the requested engine torque is not greater than the maximum allowed engine torque value, the algorithm proceeds to step 138. If the requested engine torque is greater than the maximum allowed engine torque value, the algorithm proceeds to step 136.

Step 136 sets the requested engine torque equal to the maximum allowed engine torque value.

Step 138 sends the requested engine torque value to the engine controller 36, and this causes the engine controller 36 to control the engine torque to achieve the requested engine torque.

Step 142 gradually reduces the pressure applied to an off-going clutch (such as clutch H) and determines when that clutch begins to slip, such as described more fully in aforementioned U.S. Pat. No. 6,193,630. After step 142, the algorithm proceeds to previously described steps 144-152.

Thus, to summarize, the system described herein controls the engine torque during the shift. For an upshift, the engine torque is adjusted or controlled based on detected clutch slip. For a downshift, the engine torque is adjusted or controlled based on actual sensed engine torque provided that the PTO is not engaged. For downshifts such that the PTO is engaged, the engine torque is adjusted or controlled based on detected clutch slip. Thus, the torque control is based on the torque load that the transmission is subject to at the start of the shift.

The load and torque boost calculation is based on the pressure at which the off-going range clutch begins to slip. At that point, the transmission controller requests a torque level from the engine controller (for example, a torque level 20% over the present torque), and the shift proceeds. During the shift, the engine controller controls the engine so that the engine generates a constant requested torque. When the off-going range clutch is commanded off, the boost is no longer needed, and the transmission controller directs the engine controller to return to normal governed operation.

With this system, torque control is based on the torque load that the system is under at the start of the shift, as measured by the slip pressure of the off-going range clutch, whereas a previous system increased the torque over time until the on-coming clutch begins to slip. With the present system, clutch slip occurs under the normal engine operation and the engine torque boost does not occur until after the clutch slips. The prior art begins the shift, slowly increases the torque, and then watches for clutch slippage, at which point the shift proceeds.

While the present invention has been described in conjunction with a specific embodiment, it is understood that many alternatives, modifications and variations will be apparent to those skilled in the art in light of the foregoing description. For example, the shift control method described herein could be applied to many different powershift transmissions where there is also an engine controller capable of controlling engine torque, and to any shift of such a transmission where the technique would be beneficial. Accordingly, this invention is intended to embrace all such alternatives, modifications and variations which fall within the spirit and scope of the appended claims.

1. In a vehicle having a powershift transmission driven by an engine, a transmission controller for controlling the transmission and an engine controller for controlling the engine, the powershift transmission having fluid pressure operated clutches for controlling flow of torque through the transmission, a method of controlling, in response to a shift command, a commanded shift of the powershift transmission, the method comprising:
determining a requested engine torque value; and
controlling engine torque to said requested engine torque during swapping of said clutches to complete the requested shift.

2. The method of claim 1, wherein:
the requested engine torque value is determined as a function of slippage of one of the clutches.

3. The method of claim 1, wherein:
the requested engine torque value is determined as a function of a clutch pressure associated with a certain amount of slippage of one of the clutches.

4. The method of claim 1, wherein:
the requested engine torque value is determined as a function of actual sensed engine torque.

5. The method of claim 1, wherein:
the requested engine torque value is derived from a fuel flow value provided by the engine controller.

6. The method of claim 1, wherein:
the engine controller limits engine torque to the requested engine torque value.
